(19) United States
(12) Patent Application Publication
(10) Pub. No.: US 2006/0104338 A1
(43) Pub. Date: May 18, 2006

(54) Communication apparatus

(75) Inventor: Seong-joon Lee, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/247,240

(22) Filed: Oct. 12, 2005

(30) Foreign Application Priority Data
Nov. 17, 2004 (KR) 2004-0094324

(51) Int. Cl. H04L 5/16

(52) U.S. Cl. 375/220

(57) ABSTRACT

A communication apparatus includes a pair of communication connectors to be connected with a pair of external apparatuses; a communication controller to generate transmitting data to be transmitted to the pair of external apparatuses and receive receiving data from the external apparatus to perform a predetermined function; and a data path controller to control the transmitting data generated by the communication controller to be transmitted to the pair of external apparatuses through the pair of communication connectors, transmit the receiving data received through each communication connector to the communication controller, and transmit the receiving data to one of the external apparatuses through another communication connector. Thus, the communication apparatus can simplify a communication system, save communication time, and make data communication possible regardless of a connecting order of a communication connector.

### CROSS-REFERENCE TO RELATED APPLICATIONS

This application claims priority from Korean Patent Application No. 2004-0094324, filed on Nov. 17, 2004 in the Korean Intellectual Property Office, the disclosure of which is incorporated herein by reference.

### BACKGROUND OF THE INVENTION

1. Field of the Invention

The present invention relates to a communication apparatus, and more particularly, to a communication apparatus which can simplify a communication system, save communication time, and make data communication possible regardless of a connecting order of a communication connector.

2. Description of the Related Art

Usually, serial communication is used to allow a separate control unit to control an electric apparatus (hereinafter, referred to as “communication apparatus”) to communicate with an external device.

The serial communication has a basic communication structure of 1:1, so that serial communication integrated circuits (IC) are needed as much as the number of communication apparatuses when the control unit controls the plurality of communication apparatuses.

FIG. 1 illustrates a connection between a plurality of conventional communication apparatuses and a personal computer (PC) controlling them.

As shown in FIG. 1, a PC 100 comprises N serial ICs 102a, 102b, 102c, 102d to control N communication apparatuses 110a, 110b, 110c, 110d; N serial drivers 104a, 104b, 104c, 104d to drive the respective N serial ICs 102a, 102b, 102c, 102d; and N serial ports 106a, 106b, 106c, 106d to receive/transmit serial communication data.

Further, each communication apparatus 110a, 110b, 110c, 110d comprises a serial driver (not shown), a serial IC (not shown) and one serial port (not shown) to be connected with the respective serial ports 106a, 106b, 106c, 106d provided in the PC 100.

Thus, each of serial ports 106a, 106b, 106c, 106d of the PC 100 and each serial port of the communication apparatuses 110a, 110b, 110c, 110d are connected by a cable, so that each serial IC 102a, 102b, 102c, 102d of the PC 100 can communicate with each serial IC of the communication apparatuses 110a, 110b, 110c, 110d, thereby allowing the PC 100 to the respective communication apparatuses 110a, 110b, 110c, 110d.

When the PC 100 controls each communication apparatus 110a, 110b, 110c, 110d, N serial ICs 102a, 102b, 102c, 102d cannot communicate at the same time but should communicate individually with the serial IC of the communication apparatuses 110a, 110b, 110c, 110d. In other words, until communication using serial IC (e.g., 102a) is finished, it is impossible to use the serial IC 102b, 102c, 102d and other serial port 106b, 106c, 106d for communication with other communication apparatus 110b, 110c, 110d.

In such a communication system, when the PC 100 controls the plurality of communication apparatuses 110a, 110b, 110c, 110d, communication time increases because of time taken to alter the ports 106, 106b, 106c, 106d; and the communication system becomes complicated and it is impossible to control a long distance communication apparatus 110a, 110b, 110c, 110d because the PC 100 and each communication apparatus 110a, 110b, 110c, 110d are connected by a cable.

Accordingly, there has recently been proposed a communication system having configuration as shown in FIG. 2.

As shown in FIG. 2, a plurality of communication apparatuses 130a, 130b, 130c, 130d are sequentially connected to each other in series and one of them is connected to a PC 120, so that the plurality of communication apparatuses 130a, 130b, 130c, 130d are controlled by the PC 120.

In this case, the PC 120 is connected with only one communication apparatus 130a, so that the PC 120 is need of only one serial IC, only one serial driver and only one serial connector instead of N serial ICs 102a, 102b, 102c, 102d; N serial drivers 104a, 104b, 104c, 104d; and N serial ports 106a, 106b, 106c, 106d shown in FIG. 1.

Further, as shown in FIG. 3, each communication apparatus 130a, 130b, 130c, 130d comprises a pair of serial connectors 132a and 132b, each comprising a transmitting terminal Tx and a receiving terminal Rx; a pair of serial drivers 134a and 134b, each comprising the transmitting terminal Tx and the receiving terminal Rx; a serial IC 136 comprising the transmitting terminal Tx and the receiving terminal Rx; and diodes 138a and 138b to alter a data path. Here, the serial connectors 132a and 132b are divided into an input part and an output part, respectively. Further, the serial drivers 134a and 134b are divided into an input part and an output part, respectively. Thus, the serial connectors 132a and 132b and the serial drivers 134a and 134b are correspondingly connected to each other according to the input or output part.

With this configuration, transmitting data transmitted through the transmitting terminal Tx of the serial IC 136 is not transmitted to the output serial connector 132b because of the diodes 138a and 138b, but transmitted through the transmitting terminal Tx of the input serial connector 132a. Further, receiving data received through the input serial connector 132a is transmitted to the serial IC 136 and at the same time outputted through the transmitting terminal Tx of the output serial connector 132b. Also, the receiving data received through the output serial connector 132b is not transmitted to the serial IC 136 because of the diodes 138a and 138b, but outputted through the transmitting terminal Tx of the input serial connector 132a.

FIGS. 4 and 5 are block diagrams illustrating connection for data communication when a connecting order of a conventional serial connector is altered.

In a communication system as shown in FIG. 4, a first communication apparatus 130a comprises an input serial connector 142a connected with the PC 120, and an output serial connector 142b connected to an input serial connector 152a of a second communication apparatus 130b. Further, an output serial connector 152b of the second communication apparatus 130b is connected with an input serial connector (not shown) of a third communication apparatus 130c. Likewise, the plurality of communication apparatuses 130a, 130b, 130c are sequentially connected in series from the PC 120.

When the first communication apparatus 130a receives control data from the PC 120 through a receiving terminal Rx of the input serial connector 142a, the control data is transmitted to the receiving terminal Rx of an input serial driver 144a. Then, the input serial driver 144a converts the received control data to be recognizable for the serial IC 146, and transmits it to the serial IC 146 and at the same time outputs it to the transmitting terminal Tx of an output serial driver 144b. Then, the output serial driver 144b converts the data to be transmittable to the outside, and transmits it through the transmitting terminal Tx of an output serial connector 142b.

Then, the receiving terminal Rx of the input serial connector 152a provided in the second communication apparatus 130b receives the data from the transmitting terminal Tx of the output serial connector 142b provided in the first communication apparatus 130a, and then the data is transmitted toward the serial IC 156 and the third communication apparatus 130c, similar to the data flow of the first communication apparatus 130a. Likewise, each communication apparatus 130a, 130b, 130c receives the control data from the PC 120 and transmits it to the next communication apparatus 130a, 130b, 130c, thereby allowing the plurality of communication apparatuses connected to each other to receive the control data from the PC 120.

Further, the transmitting data transmitted from the serial IC 146 of the first communication apparatus 130a is transmitted to the PC 120 through the transmitting terminal Tx of the input serial connector 142a. Also, the transmitting data transmitted from the serial IC 156 of the second communication apparatus 130b is transmitted to the PC 120 via the transmitting terminal Tx of the input serial connector 152a provided in the second communication apparatus 130b, and via the output serial connector 142b, the output serial driver 144b, the input serial driver 144a, and the input serial connector 142a of the first communication apparatus 130a. Thus, the data can be transmitted from each communication apparatus 130a, 130b, 130c to the PC 120.

However, when the connecting order of the serial connector of FIG. 4 is altered as shown in FIG. 5 and then is configured as the communication system, a problem arises as follows.

In the communication system shown in FIG. 5, the first communication apparatus 130a comprises the input serial connector 142a connected with the PC 120, and the output serial connector 142b connected with the output serial connector 152b of the second communication apparatus 130b. Further, the input serial connector 152a of the second communication apparatus 130b is connected with the input or output serial connector (not shown) of the third communication apparatus 130c.

When the plurality of communication apparatuses 130a, 130b, 130c are sequentially connected to each other in series from the PC 120 in the foregoing manner and the first communication apparatus 130a receives the control data from the PC 120 through the receiving terminal Rx of the input serial connector 142a, the control data is transmitted to the receiving terminal Rx of the input serial driver 144a. Then, the input serial driver 144a converts the received control data to be recognizable for the serial IC 146, and transmits it to the serial IC 146. Further, the data is transmitted to the transmitting terminal Tx of the output serial driver 144b. Likewise, the output serial driver 144b converts the data to be transmittable to the outside, and transmits it through the transmitting terminal Tx of the output serial connector 142b.

Then, the receiving terminal Rx of the output serial connector 152b provided in the second communication apparatus 130b receives the data from the transmitting terminal Tx of the output serial connector 142b provided in the first communication apparatus 130a, and the received data is transmitted to the third communication apparatus 130c via the output serial driver 154b, the diode 158a, the input serial driver 154a, and the input serial connector 152a. However, the data is not transmitted to the serial IC 156.

Further, the transmitting data transmitted from the serial IC 146 of the first communication apparatus 130a is transmitted to the PC 120 through the transmitting terminal Tx of the input serial connector 142a. However, the transmitting data transmitted from the serial IC 156 of the second communication apparatus 130b is transmitted to the third communication apparatus 130c via the transmitting terminal Tx of the input serial connector 152a, but is not transmitted to the PC 120.

Additionally, when the PC 120 is connected to the output serial connector 142b of the first communication apparatus 130a, the serial IC 146 of the first communication apparatus 130 cannot receive the control data from the PC 120, and cannot transmit the transmitting data from the serial IC 146 of the first communication apparatus 130a to the PC 120.

That is, there are limits such that the PC 120 is connected with the input serial connector 142a and the output serial connector 142b is connected with the input serial connector 152a with respect to the neighbor communication apparatuses 130a and 130c, such that the connection configuration is similar to that which is shown in FIG. 4.

### SUMMARY OF THE INVENTION

It is an aspect of the present invention to provide a communication apparatus which can simplify a communication system, save communication time, and make data communication possible regardless of a connecting order of a communication connector.

The foregoing and/or other aspects of the present invention are also achieved by providing a communication apparatus comprising a pair of communication connectors to be connected with a pair of external apparatuses; a communication controller to generate transmitting data to be transmitted to the external apparatus and receive receiving data from the external apparatus to perform a predetermined function; and a data path controller to control the transmitting data generated by the communication controller to be transmitted to the pair of external apparatuses through the pair of communication connectors, transmit the receiving data received through each communication connector to the communication controller, and transmit the receiving data to the external apparatus through another communication connector.

According to an aspect of the present invention, the data path controller comprises a first logic device to transmit the receiving data received through each communication connector to the communication controller; a second logic device to output corresponding data through one of the communication connectors when it receives either the transmitting data generated by the communication controller or the receiving data inputted through the other one of the communication connectors; and a third logic device to output corresponding data through the other one of the communication connectors when it receives either the transmitting data generated by the communication controller or the receiving data inputted through the one of the communication connectors.

According to an aspect of the present invention, the first logic device comprises an OR gate to OR-operate the receiving data inputted through the respective communication connectors and then transmit the OR-operated data to the communication controller.

According to an aspect of the present invention, the second logic device comprises an OR gate to OR-operate the transmitting data generated by the communication controller with the receiving data inputted through one of the communication connectors and then output the OR-operated data through the other one of the communication connectors.

According to an aspect of the present invention, the third logic device comprises an OR gate to OR-operate the transmitting data generated by the communication controller with the receiving data inputted through one of the communication connectors and then output the OR-operated data through the other one of the communication connectors.

### BRIEF DESCRIPTION OF THE DRAWINGS

The above and/or other aspects of the present invention will become apparent and more readily appreciated from the following description of exemplary embodiments, taken in conjunction with the accompanying drawings of which:

FIGS. 1 and 2 are block diagrams illustrating connections between a plurality of conventional communication apparatuses and a personal computer;

FIG. 3 is a block diagram illustrating internal configuration of each conventional communication apparatus;

FIGS. 4 and 5 are block diagrams illustrating connection for data communication when a connecting order of a conventional serial connector is altered;

FIG. 6 is a block diagram illustrating connection between a plurality of communication apparatuses and a personal computer according to an exemplary embodiment of the present invention;

FIG. 7 is a block diagram illustrating internal configuration of each communication apparatus according to an exemplary embodiment of the present invention; and

FIGS. 8 and 9 are block diagrams illustrating a connection for data communication when a connecting order of a serial connector is altered according to an exemplary embodiment of the present invention.

### DETAILED DESCRIPTION OF EXEMPLARY EMBODIMENTS OF THE PRESENT INVENTION

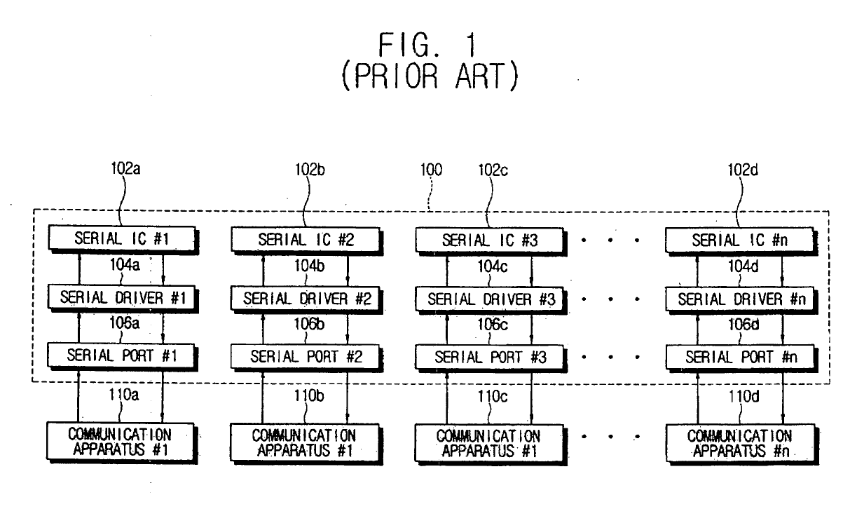

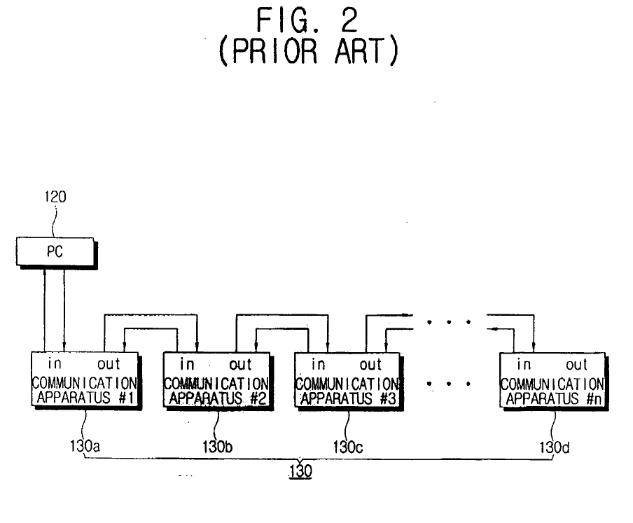

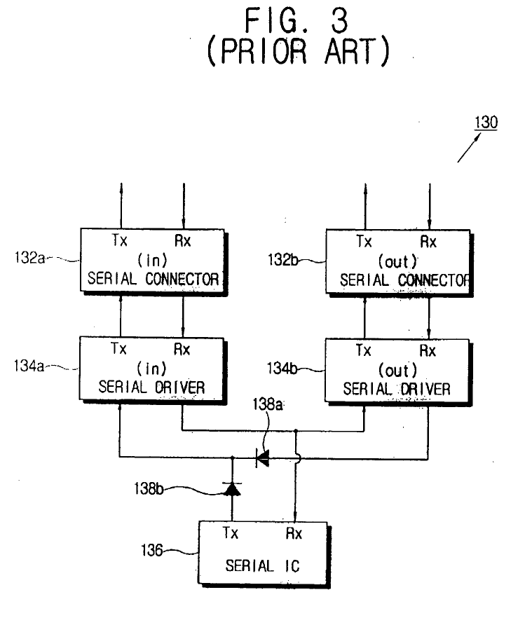

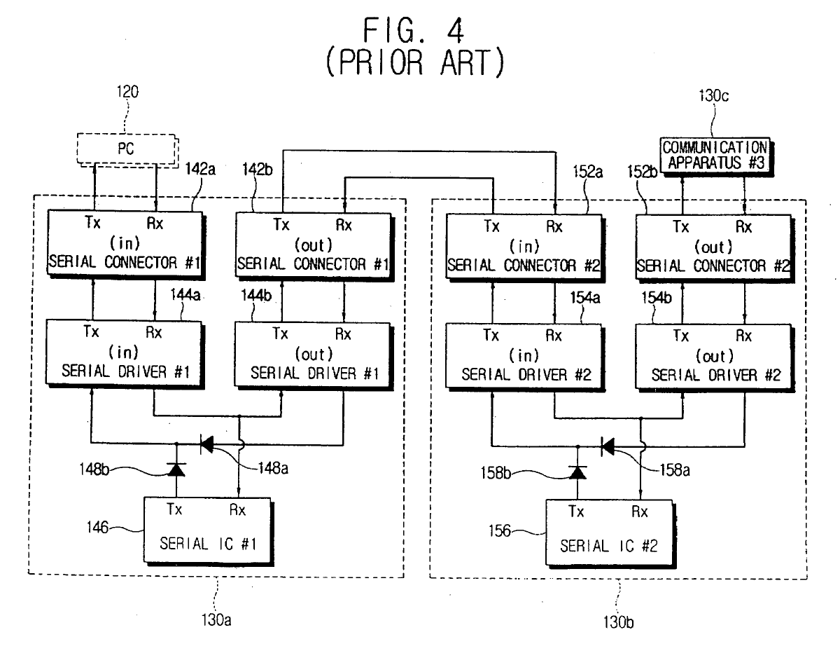

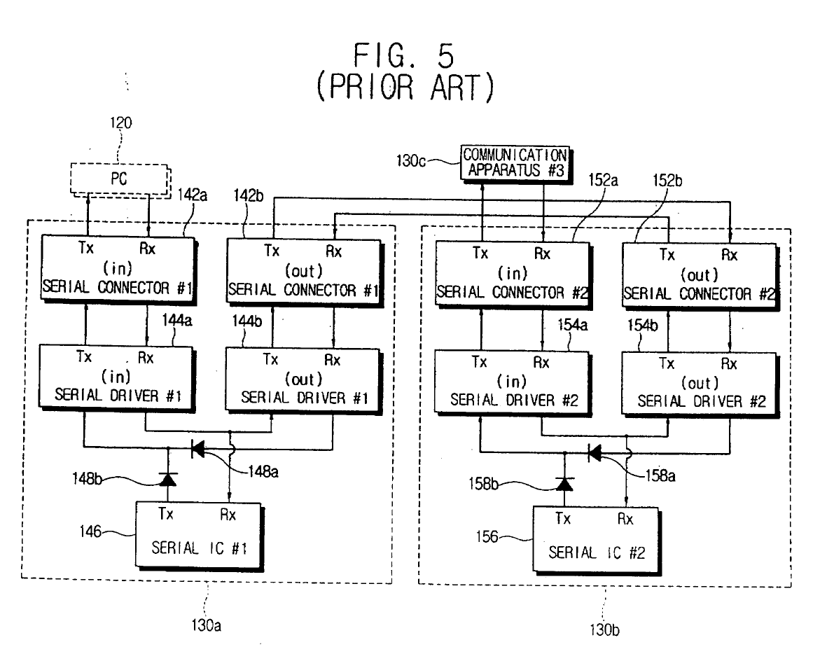

Reference will now be made in detail to the exemplary embodiments of the present invention, examples of which are illustrated in the accompanying drawings, wherein like reference numerals refer to like elements throughout. The exemplary embodiments are described below in order to explain the present invention with reference to FIGS. 1, 4A and 4B.

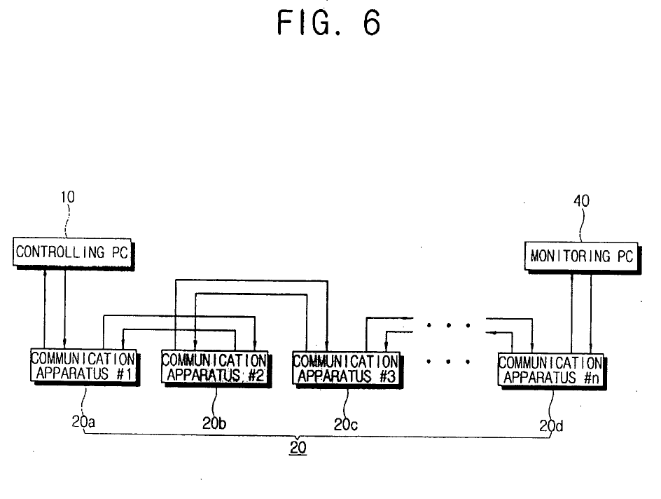

FIG. 6 is a block diagram illustrating a connection between a plurality of communication apparatuses and personal computers, according to an exemplary embodiment of the present invention.

As shown in FIG. 6, a plurality of communication apparatuses 20a, 20b, 20c, 20d are sequentially connected to each other in series from a controlling PC 10. Further, the communication apparatuses 20a, 20b, 20c, 20d are connected by a cable regardless of an input serial connector and an output serial connector. Meanwhile, the nth communication apparatus 20d is connected with a monitoring PC 40.

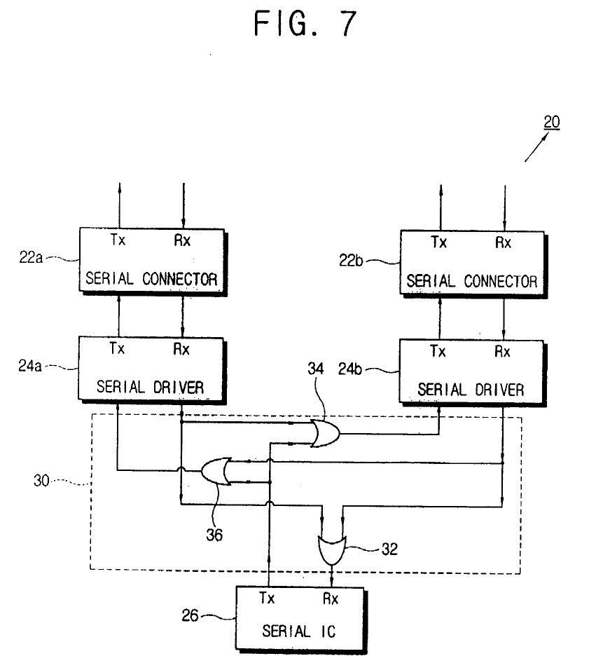

FIG. 7 is a block diagram illustrating internal configuration of each communication apparatus according to an exemplary embodiment of the present invention.

Referring to FIG. 7, each communication apparatus comprises a pair of serial connectors 22a and 22b used as a communication connector; a pair of serial drivers 24a and 24b used as a communication driver; a serial IC 26 used as a communication controller; and a data path controller 30 for controlling a data path.

The serial drivers 24a and 24b converts data received through the serial connectors 22a, 22b to be recognizable for the serial IC 26, or converts data generated by the serial IC 26 to be transmittable to the outside.

The serial IC 26 generates the data to be transmitted to the PCs 10, 40 or the communication apparatus 20 connected to the serial connector 22a, 22b, and receives the data from the PC 10, 40 or the communication apparatus 20, thereby performing a predetermined function.

Here, each of the serial connectors 22a, 22b, the serial drivers 24a, 24b, and the serial IC 26 comprises a transmitting terminal Tx to transmit the data, and a receiving terminal Rx to receive the data. In each communication apparatus 20, the transmitting terminals Tx are correspondingly connected to each other, and the receiving terminals Rx are correspondingly connected to each other.

The data path controller 30 controls the data generated by the serial IC 26 to be transmitted to the communication apparatus 20 or the PC 10, 40 connected thereto through the pair of serial connectors 22a and 22b. Further, the data path controller 30 controls the data received through one of the serial connectors 22a and 22b to be transmitted to the serial IC 26, and at the same time controls the data to be transmitted to the PC 10, 40 or the communication apparatus 20 connected to the other of the serial connectors 22a and 22b.

Here, the data path controller 30 comprises a first logic circuit (OR gate) 32 to OR-operate the data received through the respective serial connector 22a, 22b and transmit it to the serial IC 26; a second logic circuit (OR gate) 34 to OR-operate the data generated by the serial IC 26 with the data received through a first serial connector 22a and transmit it to a second serial connector 22b; and a third logic circuit (OR gate) 36 to OR-operate the data generated by the serial IC 26 with the data received through the second serial connector 22b and transmit it to the first serial connector 22a.

The first OR gate 32 transmits the data to the serial IC 26 so long as the data is inputted through either the first serial connector 22a or the second serial connector 22b.

The second and third OR gates 34 and 36 transmit the data generated by the serial IC 26 to the outside through the respective serial connectors 22a and 22b. Further, each of the second and third OR gates 34 and 36 receives the data through one of the serial connectors 22a and 22b and transmits it through the other one of the serial connectors 22b or 22a.

Here, if each communication apparatus 20 transmits the data to the controlling PC 10, the communication apparatus 20 shares one data line with another communication apparatus 20 through the second OR gate 34 and the third OR gate 36, so that a protocol should be defined to prevent the data of the respective communication apparatuses 20 from being transmitted at the same time.

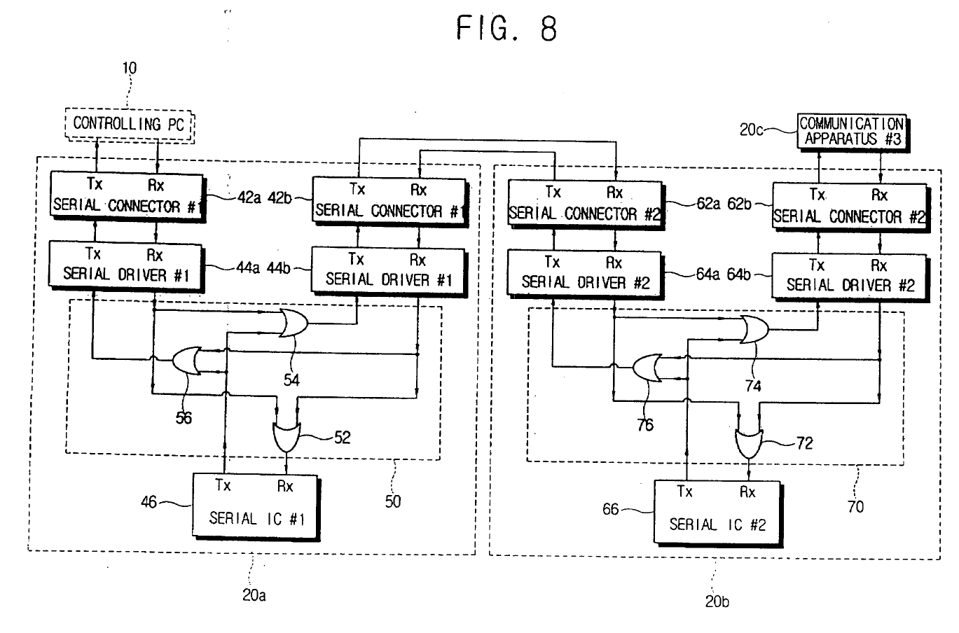

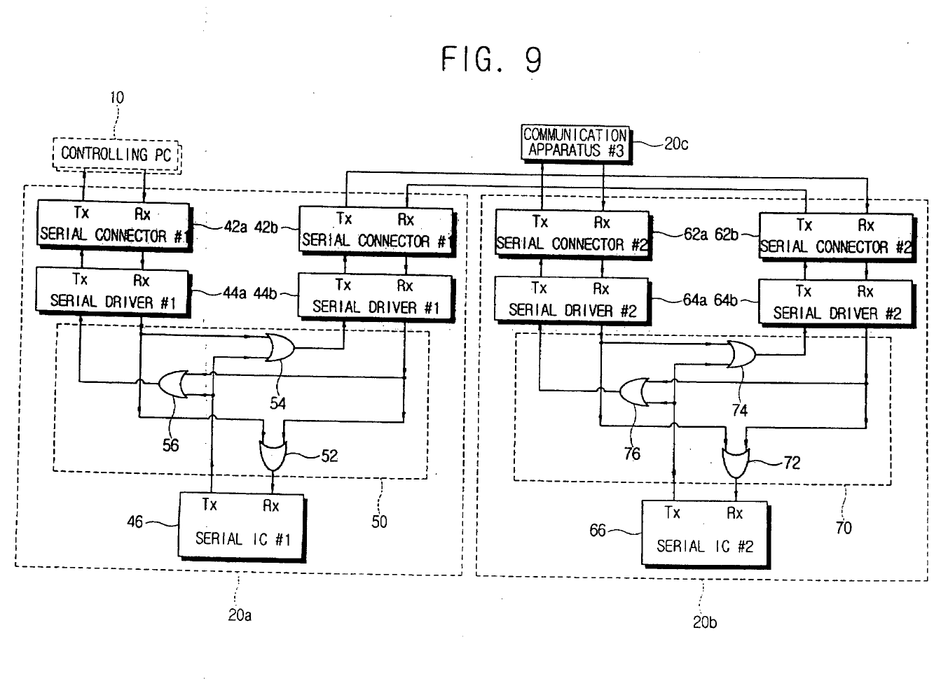

FIGS. 8 and 9 are block diagrams illustrating connection for data communication when a connecting order of a serial connector according to an exemplary embodiment of the present invention is altered.

In a communication system of FIG. 8, a first communication apparatus 20a comprises a first serial connector 42a connected with the controlling PC 10, and a second serial connector 42b connected with a first serial connector 62a of a second communication apparatus 20b. Further, a second serial connector 62b of the second communication apparatus 20b is connected with one of the serial connectors (not shown) provided in a third communication apparatus 20c. Likewise, the plurality of communication apparatuses 20a, 20b, 20c are sequentially connected to each other in series from the controlling PC 10.

When the first communication apparatus 20a receives control data from the controlling PC 10 through a receiving terminal Rx of one serial connector 42a, the control data is transmitted to the receiving terminal Rx of the serial driver 44a. Then, the serial driver 44a converts the received control data to be recognizable for the serial IC 46, and outputs the control data to the first and second OR gates 52 and 54. The first OR gate 52 transmits the received control data to the serial IC 46, and the second OR gate 52 transmits the received control data to the receiving terminal Rx of the serial connector 62a of the second communication apparatus 20b through respective transmitting terminals Tx of the serial driver 44b and the serial connector 42b.

In the second communication apparatus 20b, the control data received from the controlling PC 10 through the receiving terminal Rx of the serial connector 62a is transmitted to the serial IC 66 and the third communication apparatus 20c through the first OR gate 72 and the second OR gate 74, like data flow of the first communication apparatus 20a.

Further, the data transmitted from the serial IC 46 of the first communication apparatus 20a is transmitted to the second OR gate 54 and the third OR gate 56. The second OR gate 54 and the third OR gate 56 outputs the transmitting data of the serial IC 46 to the respective serial drivers 44a and 44b. Then, the respective serial drivers 44a and 44b converts the transmitting data to be transmittable to the outside and then transmits it to the controlling PC 10 and the second communication apparatus 20b through the respective serial connectors 42a and 42b.

Also, the data transmitted from the serial IC 66 of the second communication apparatus 20b is transmitted to the second OR gate 74 and the third OR gate 76. Then, the second OR gate 74 and the third OR gate 76 transmit the data to the first communication apparatus 20a and the third communication apparatus 20c through the respective serial connectors 62a and 62b.

Thus, the control data can be transmitted from the controlling PC 10 to each serial IC of the first, second and third communication apparatuses 20a, 20b and 20c. Further, the transmitting data can be transmitted from each serial IC of the first, second and third communication apparatuses 20a, 20b and 20c to the neighboring communication apparatus, the controlling PC 10, etc.

Meanwhile, when the connecting order of the serial connector of FIG. 8 is altered as shown in FIG. 9 and then it is configured as the communication system, data communication is possible through the following data flow.

When the first communication apparatus 20a receives the control data from the controlling PC 10 through a receiving terminal Rx of one serial connector 42a, the control data is transmitted to the receiving terminal Rx of the serial driver 44a. Then, the serial driver 44a converts the received control data to be recognizable for the serial IC 46, and outputs the control data to the first and second OR gates 52 and 54. The first OR gate 52 transmits the received control data to the serial IC 46, and the second OR gate 54 transmits the received control data to the receiving terminal Rx of the serial connector 62b of the second communication apparatus 20b through the respective transmitting terminals Tx of the serial driver 44b and the serial connector 42b.

In the second communication apparatus 20b, the control data received from the controlling PC 10 through the receiving terminal Rx of the serial connector 62b is transmitted to the serial IC 66 and the third communication apparatus 20c through the first OR gate 72 and the third OR gate 76.

Further, the data transmitted from the serial IC 46 of the first communication apparatus 20a is transmitted to the second OR gate 54 and the third OR gate 56. The second OR gate 54 and the third OR gate 56 outputs the transmitting data of the serial IC 46 to the respective serial drivers 44a and 44b. Then, the respective serial drivers 44a and 44b converts the transmitting data to be transmittable to the outside and then transmits it to the controlling PC 10 and the second communication apparatus 20b through the respective serial connectors 42a and 42b.

Also, the data transmitted from the serial IC 66 of the second communication apparatus 20b is transmitted to the second OR gate 74 and the third OR gate 76. Then, the second OR gate 74 and the third OR gate 76 transmit the data to the first communication apparatus 20a and the third communication apparatus 20c through the respective serial connectors 62a and 62b.

Thus, the data communication is possible even though the connecting order of the serial connector is altered. Hence, the PC is connectable to the output serial connector as well as the input serial connector, so that the monitoring PC together with the controlling PC can be connected in addition to the communication apparatus.

According to an exemplary embodiment of the present invention, there are provided a pair of communication connectors to be connected with a pair of external apparatuses; a communication controller to generate transmitting data to be transmitted to the external apparatus and receive receiving data from the external apparatus to perform a predetermined function; and a data path controller to control the transmitting data generated by the communication controller to be transmitted to the pair of external apparatuses through the pair of communication connectors, transmit the receiving data received through each communication connector to the communication controller, and transmit the data to the external apparatus through another communication connector, so that a communication system is simplified, communication time is saved, and data communication is possible regardless of a connecting order of a communication connector.

As described above, an exemplary embodiment of the present invention provides a communication apparatus which can simplify a communication system, save communication time, and make data communication possible regardless of a connecting order of a communication connector.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A communication apparatus comprising:
a pair of communication connectors to be connected with a pair of external apparatuses;
a communication controller which generates transmitting data to be transmitted to the pair of external apparatuses and receives receiving data from the pair of external apparatuses to perform a predetermined function; and
a data path controller which controls the transmitting data generated by the communication controller to be transmitted to the pair of external apparatuses through the pair of communication connectors, transmits the receiving data received through each of the communication connectors to the communication controller, and transmits the receiving data to one of the pair of external apparatuses through one of the pair of communication connectors.

2. The communication apparatus according to claim 1, wherein the data path controller comprises:
a first logic device which transmits the receiving data received through each of the communication connectors to the communication controller;
a second logic device which outputs corresponding data through said one of the pair of communication connectors if said second logic device receives the transmitting data generated by the communication controller or the receiving data input through another one of the pair of communication connectors; and
a third logic device which outputs corresponding data through said another one of the pair of communication connectors if said third logic device receives one of the transmitting data generated by the communication controller and said at least a first portion of the receiving data input through the one of the pair of communication connectors.

3. The communication apparatus according to claim 2, wherein the first logic device comprises an OR gate which performs an OR operation on the receiving data inputted through the respective communication connectors and then transmit the OR-operated data to the communication controller.

4. The communication apparatus according to claim 2, wherein the second logic device comprises an OR gate which performs an OR operation on the transmitting data generated by the communication controller with the receiving data input through said another one of the pair of communication connectors and then outputs the transmitting data through said one of the pair of communication connectors.

5. The communication apparatus according to claim 2, wherein the third logic device comprises an OR gate which performs an OR operation on the transmitting data generated by the communication controller with the receiving data input through said one of the pair of communication connectors and then outputs the transmitting data through said another one of the pair of communication connectors.
